(19) United States
(12) Patent Application Publication
(10) Pub. No.: US 2008/0162420 A1
(43) Pub. Date: Jul. 3, 2008

(54) METHODS AND SYSTEMS TO RETRIEVE INFORMATION FROM DATA SOURCES

(76) Inventors: Mark H. Ahrens, Milford, CT (US); David S. Dyson, Vincentown, NJ (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/866,335

(22) Filed: Oct. 2, 2007

Related U.S. Application Data
(60) Provisional application No. 60/863,736, filed on Oct. 31, 2006.

(51) Int. Cl. G06F 17/30

(52) U.S. Cl. 707/2; 707/100; 707/E17.005; 707/E17.044

(57) ABSTRACT

Methods and systems to retrieve information from data sources are disclosed. An example method involves receiving a first criterion associated with a native data source and storing the first criterion in a first data structure in response to a user navigating from a native report corresponding to the native data source to a nonnative report corresponding to a nonnative data source. An identifier is then associated with the first data structure. The first criterion is then mapped to a second criterion associated with a nonnative data source, and information is retrieved from the nonnative data source based on the second criterion.

### RELATED APPLICATIONS

This patent claims the benefit of U.S. provisional application Ser. No. 60/863,736, filed on Oct. 31, 2006, which is hereby incorporated by reference herein in its entirety.

### FIELD OF THE DISCLOSURE

This disclosure relates generally to processor systems and, more particularly, to methods and systems to retrieve information from data sources.

### BACKGROUND

Market data analysis techniques are often essential to making development and planning decisions in many businesses. Businesses often use data analysis software to perform different types of market analyses. To specify particular analyses or to retrieve analysis results from a data source, the data analysis software often provides a user interface that enables users to search for desired data or type of data by specifying particular criteria. The available criteria or type of data may change between different data sources so that when users wish to view data or data analyses from different data sources, the user needs to re-select or re-specify criteria that is pertinent to the particular data source of interest. In addition, if a user needs to use a different application to access a particular data source, the user must re-select or re-specify criteria corresponding to that application and/or data source. Having to re-specify data selection criteria each time a user switches to a different data source or a different application can be cumbersome and can lead to retrieving the wrong data and/or spending too much time in trying to retrieve the correct data, thus creating a very inefficient and error-prone process.

### BRIEF DESCRIPTION OF THE DRAWINGS

FIG. 1 depicts an example graphical user interface of an application used to retrieve report information from a plurality of separate data sources without requiring a user to repeatedly provide selection criteria indicative of the information to be retrieved.

FIG. 2 is a block diagram of an example system configured to retrieve information from a plurality of data sources.

FIG. 3 is an example table of contents that may be used to implement the table of contents of FIG. 2.

FIG. 4 depicts an example table of contents written in an extensible markup language (XML) that may be used to implement the example table of contents of FIG. 3.

FIG. 5 depicts an example mapping table format that may be used to implement the mapping table of FIG. 2.

FIG. 6 is an example mapping table data structure implemented in accordance with the example mapping table format of FIG. 5.

FIG. 7 is an example timing diagram representative of example communication transactions between entities of the example system of FIG. 2.

FIG. 8 is a flowchart representative of example machine readable instructions that may be executed by one or more entities of the example system of FIG. 2 to enable the application of FIG. 1 to retrieve information from a plurality of separate data sources without requiring a user to repeatedly provide selection criteria indicative of the information to be retrieved.

FIG. 9 is a block diagram of an example processor system that may be used to execute the example machine readable instructions of FIG. 8 to implement the example systems, apparatus, and/or methods described herein.

### DETAILED DESCRIPTION

The example systems, methods, apparatus, and/or articles of manufacture described herein may be used to enable an application to retrieve information from two or more (i.e., a plurality) of separate data sources without requiring a user to repeatedly provide selection criteria indicative of the information to be retrieved. In particular, the example systems, methods, and apparatus described herein provide an application the ability to receive user-provided selection criteria from a user, to store (e.g., persist, save, etc.) the user-provided selection criteria, and to subsequently use the user-provided selection criteria a plurality of times to retrieve information from a plurality of separate (e.g., different) data sources in response to, for example, the user requesting to view the information.

In an example implementation, the example systems, methods, and apparatus described herein may be used to implement a user-accessible network-based or web-based portal (e.g., an information retrieval application) configured to access and retrieve information from a plurality of data sources and to display the information to a user. As used herein, data sources include, for example, databases, servers, applications, data structures, storage areas, or any other device, system, or process that can store and/or communicate requested information to an information retrieval application. In an example implementation used to conduct business research or market research, the user-accessible web-based portal (i.e., the portal) can be configured to display the retrieved information in, for example, report formats or in any other format (e.g., charts, paragraphs, tables, etc.) to enable a user to view the requested information. For example, a user could specify selection criteria indicative of a particular market (e.g., a geographic area, an age group, etc.) to view a particular user-specified or default report (e.g., revenues report, quantities sold report, etc.) based on the selection criteria. The portal can then retrieve the information corresponding to the user-specified selection criteria and store the user-specified selection criteria for subsequent use. That is, when the user requests to view other types of reports based on the same selection criteria, the user need not re-enter the selection criteria. Instead, the portal can use the stored user-provided selection criteria to retrieve information for any report subsequently requested by the user. To view a different report, the user merely specifies the report of interest, and the portal then automatically uses the stored user-provided selection criteria to retrieve the information for the requested report from a data source.

In some example implementations, some data sources are native data sources and other data sources are nonnative data sources (e.g., external data sources). As used herein, a native data source is configured to store and communicate information using a substantially similar or identical format or data arrangement as other native data sources and/or a data retrieval application (e.g., a portal). In addition, each of the native data sources may be configured to use the same or substantially the same data access interface protocol or data access interface format to enable an information retrieval application (e.g., a portal) to request information and receive information from any native data source using the same data format and/or data access interface protocol. The example systems, methods, and/or apparatus described herein can be used to retrieve information based on user-provided selection criteria from native and/or nonnative data sources.

An example method of retrieving information involves receiving a selection criterion (e.g., a native selection criterion) associated with information stored in a native data source, storing the native selection criterion in a first data structure, and associating an identifier (ID) with the first data structure. To retrieve information from a nonnative data source based on the native selection criterion, a mapped data structure is generated based on the ID by mapping the native selection criterion to a nonnative selection criterion associated with the information stored in the nonnative data source. The information is then retrieved from the nonnative data source based on the nonnative selection criterion in the mapped data structure.

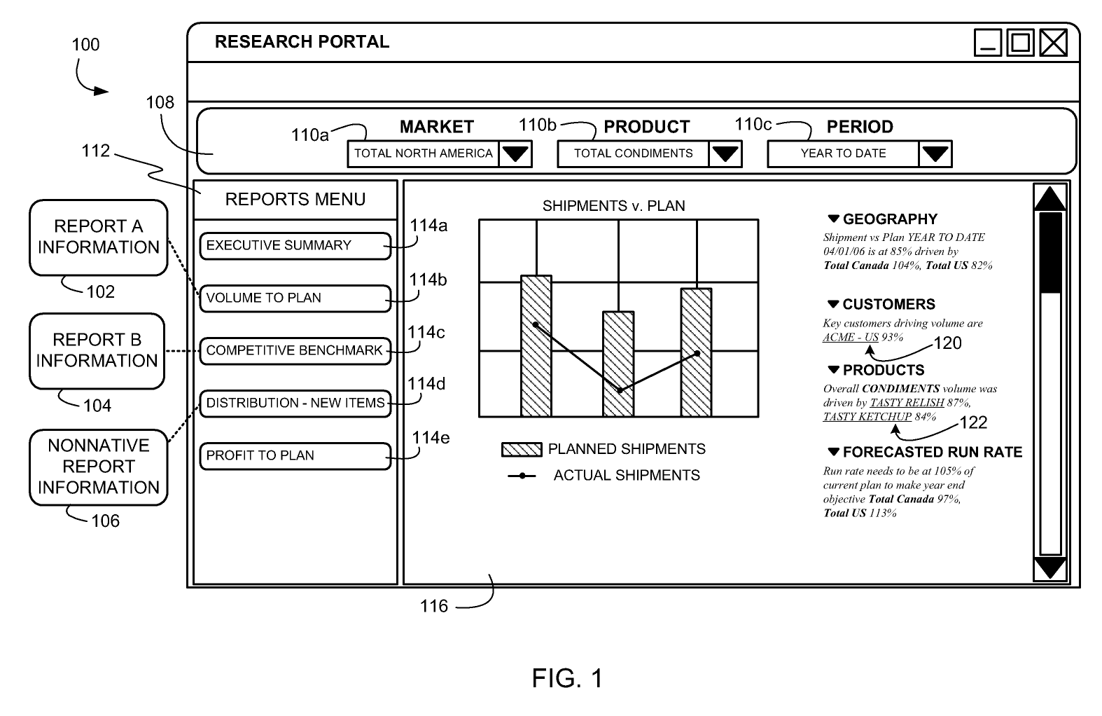

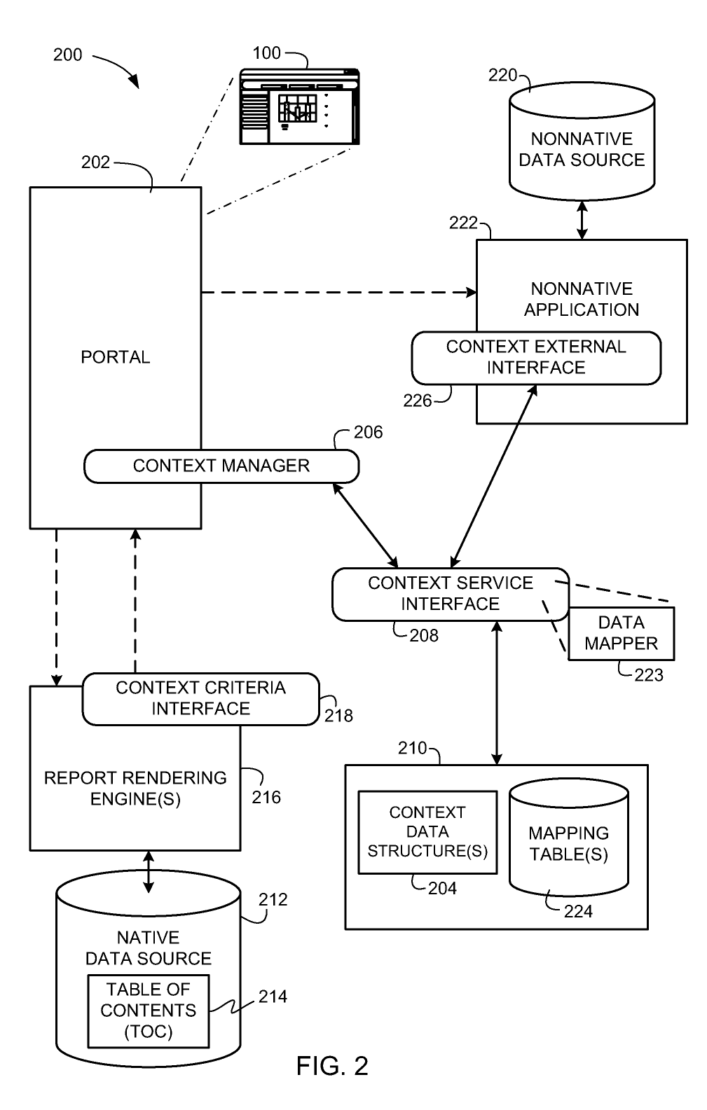

FIG. 1 depicts an example graphical user interface (GUI) 100 of an information retrieval application (e.g., the portal 202 of FIG. 2) used to retrieve report information 102, 104, and/or 106 from a plurality of separate data sources (e.g., data sources 212 and 220 of FIG. 2) without requiring a user to repeatedly provide selection criteria indicative of the information to be retrieved. To enable a user to specify selection criteria indicative of the information that the user would like to view, the GUI 100 is provided with a criteria selection toolbar 108 having a plurality of criterion selection fields 110a-c. The criterion selection fields 110a-c provide a plurality of criteria from which a user may select. As described in greater detail below, available selection criteria are provided to the criterion selection fields 110a-c using tables of contents (TOC) provided by data sources. Each data source is associated with a respective TOC that indicates the type of information that may be retrieved from that data source. For example, a data source having information associated with fast food restaurant sales may provide a TOC having selection criteria associated with, for example, regions of fast food sales, types of fast food sold, etc. In some example implementations, a data source may be associated with a plurality of TOC, each of which corresponds to a different user or user account having access (e.g., login access, data access, etc.) to the data source. The selection criteria included in each TOC may vary based on respective user accounts. For example, a user account may indicate permissible access to information associated with only a subset of selection criteria (e.g., condiment sales volume and revenue) associated with a respective data source (e.g., a data source that stores sales volumes and revenues for many different types of foods). Thus, for a particular data source, a user account may be uniquely associated with a TOC having a subset of selection criteria different from another TOC.

In the illustrated example, the criterion selection fields 110a-c are implemented using drop-down lists. In the illustrated example, a drop-down list displays selection criteria available to a user when the user clicks on the drop-down list. However, in other example implementations, the selection criterion fields 110a-c may be implemented using any other GUI control. In addition, although three criterion selection fields 110a-c are shown, the criteria selection toolbar 108 may be provided with any number of criterion selection fields 110a-c. For example, the criteria selection toolbar 108 may have one or more criterion selection fields.

To enable a user to select a type of report to view based on the user-specified criteria selected via the criteria selection toolbar 108, the GUI 100 is provided with a reports menu 112. The reports menu 112 includes a plurality of report selectors 114a-e. Each of the report selectors 114a-e corresponds to a particular data source. In the illustrated example, the ‘Volume to Plan’ report selector 114b corresponds to a native data source configured to provide the report A information 102, the ‘Competitive Benchmark’ report selector 114c corresponds to a native data source configured to provide the report B information 104, and the ‘Distribution—New Items’ report selector 114d corresponds to a nonnative data source configured to provide the nonnative report information 106.

In an example implementation, after a report is selected (e.g., a user selects one of the report selectors 114a-e or a default report is enabled upon initial login based on user account default settings), the data source configured to provide the selected report can provide its TOC to populate the available selection criteria in the criterion selection fields 110a-c. A user can then specify one or more criterion via the criteria selection toolbar 108 and one of the report selectors 114a-e to retrieve information based on the user-provided criteria from a data source corresponding to the selected one of the report selectors 114a-e. In some example implementations, native data sources may be configured to have the same criteria (e.g., native criteria) in their TOC. That is, the selection criteria from which a user can select to retrieve information from a native data source may be the same for all of the native data sources. For example, if the criterion selection fields 110a-c include native selection criteria common to native data sources associated with the report selectors 114b-c and a user specifies ‘Total North America,’ ‘Total Condiments,’ and ‘Year to Date’ in the criteria selection toolbar 108, an information retrieval application (e.g., the portal 202 of FIG. 2) can use the specified native selection criteria to retrieve report information from any or all of the native data sources without mapping the selection criteria associated with one native data source to selection criteria associated with another native data source.

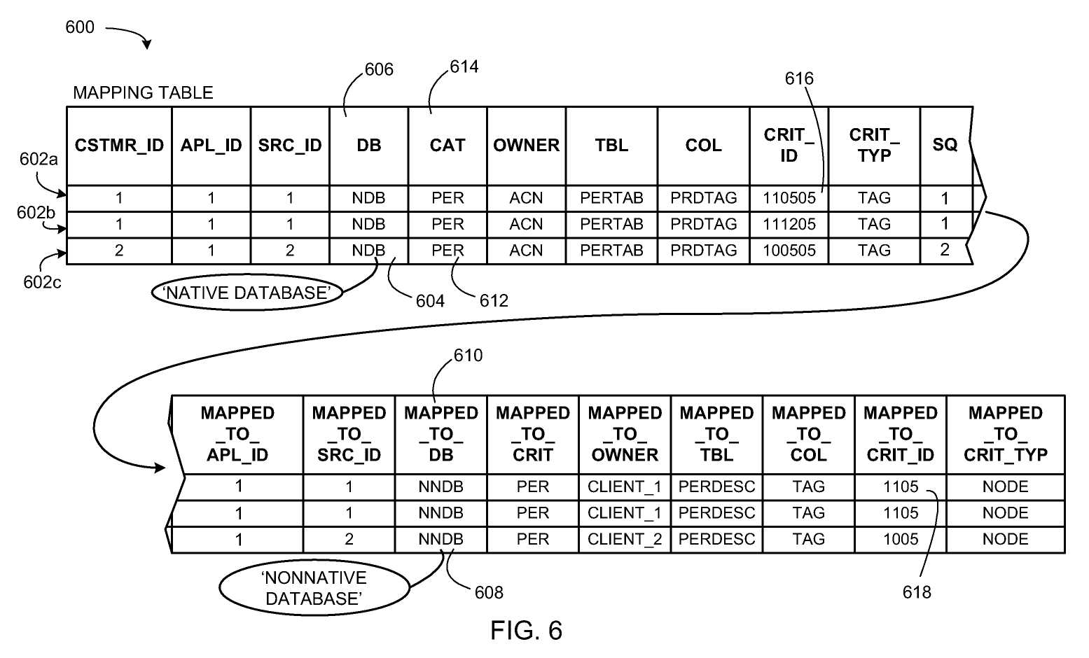

In some example implementations, the TOC for nonnative data sources may contain selection criteria (e.g., nonnative selection criteria) different from the selection criteria associated with the native data sources. Thus, in the illustrated example, when the user selects the ‘Distribution—New Items’ report selector 114d while viewing the report A information 102, the user-specified criteria (e.g., the criteria available for the report A information 102) specified via the criteria selection toolbar 108 are stored and assigned an identifier (ID). The ID can then be used to map the specified native selection criteria to corresponding selection criteria (e.g., nonnative selection criteria) associated with the nonnative data source configured to provide the nonnative report information 106 using mapping tables (e.g., the mapping table 224 of FIG. 2 and 600 of FIG. 6) as described below. If the user elects to change the selection criteria while viewing the nonnative report information 102, the selection criteria available via the criterion selection fields 110a-c will be indicative of the nonnative criteria associated with the nonnative data source that provided the nonnative report information 106. In addition to mapping native selection criteria to nonnative selection criteria, the example systems, methods, and apparatus described herein can also be used to map nonnative selection criteria to native selection criteria when a user navigates from nonnative report information (e.g., the nonnative report information 106) to native report information (e.g., the report A information 102 or the report B information 104).

To display report information, the GUI 100 is provided with a report display area 116. In the illustrated example, the report display area 116 is configured to display report information in chart format, graph format, pictorial format, and/or textual format. Also in the illustrated example, textual representations of report information may be configured to include user-selectable selection criteria 120 and 122. The selectable selection criteria 120 and 122 correspond to selection criteria that may also be available for selection via the criterion selection fields 110a-c. Thus, the selectable selection criteria 120 and 122 are provided by a data source via the TOC of that data source. When a user selects one of the selectable selection criteria 120 and 122, a corresponding one of the criterion selection fields 110a-c displays the text (e.g., ‘ACME-US’) corresponding to the selected one of the selectable selection criteria 120 and 122.

FIG. 2 is a block diagram of an example system 200 configured to retrieve information from a plurality of data sources to enable retrieving information from the plurality of data sources. To host the GUI 100 of FIG. 1 and retrieve information (e.g., the report information 102, 104, and 106 of FIG. 1) from native and/or nonnative data sources, the example system 200 is provided with a portal 202. Each time a user specifies different selection criteria via the criteria selection toolbar 108 (FIG. 1), the example portal 202 of FIG. 2 creates or instantiates a criteria context data structure 204 to store the selection criteria for use in retrieving any subsequent report information while the selection criteria remains unchanged. In the illustrated example, to generate context data structure(s), the portal 202 is provided with a context manager 206. The context manager 206 creates a context data structure (e.g., the context data structure 204) by pairing or associating a criterion type and a criterion identifier (ID) corresponding to each of the specified selection criterion to form one or more criterion type/ID pairs. For example, if the user specifies the criterion ‘North America’ via the ‘Market’ criterion selection field 110a of FIG. 1, the context manager 206 creates a criterion type/ID pair for the selection that specifies ‘Market/North America,’ in which ‘Market’ corresponds to the criterion type and ‘North America’ corresponds to the criterion ID. When the user specifies different selection criteria, the context manager 206 creates a different context data structure to store the updated selection criteria. In the illustrated example, the context manager 206 is configured to create the criterion type/ID pairs using an extensible markup language (XML) format. That is, the context manager 206 creates an XML entry for each criterion type/ID pair corresponding to each specified selection criterion. However, any other format may alternatively be used to implement the criterion type/ID pairs.

It is preferable, but not necessary, that the context manager 206 be configured to create criterion type/ID pairs when a user selects to navigate from a native report to a nonnative report or to navigate from a nonnative report to a native report. It is also preferable, but not necessary, that the context manager 206 be configured not to create criterion type/ID pairs when a user selects to navigate between different native reports associated with the same selection criteria. For example, the context manager 206 may be configured to create the criterion type/ID pairs when the GUI 100 is displaying the report A information 102 (FIG. 1) and the user selects the ‘Distribution—New Items’ report selector 114d to view the nonnative report information 106 (FIG. 1). By way of further example, the context manager 206 may be configured not to create criterion type/ID pairs when the GUI 100 is displaying the report A information 102 and the user selects the ‘Competitive Information’ report selector 114c (FIG. 1) to view the native report B information 104 (FIG. 1).

To store the context data structure 204, the example system 200 is provided with a context service interface 208. When the context manager 206 generates the context data structure 204, the context manager 206 communicates the context data structure 204 to the context service interface 208. The context service interface 208 stores the context data structure 204 in, for example, a memory 210 and assigns the context data structure 204 a context ID. In this manner, the context manager 206 or any other entity in the example system 200 can reference the context data structure 204 using the context ID. In some example implementations, the context service interface 208 may be implemented using a web-based interface that enables the portal 202 to communicate with the context service interface 208 using a web communication protocol (e.g., hyper-text transfer protocol (HTTP)).

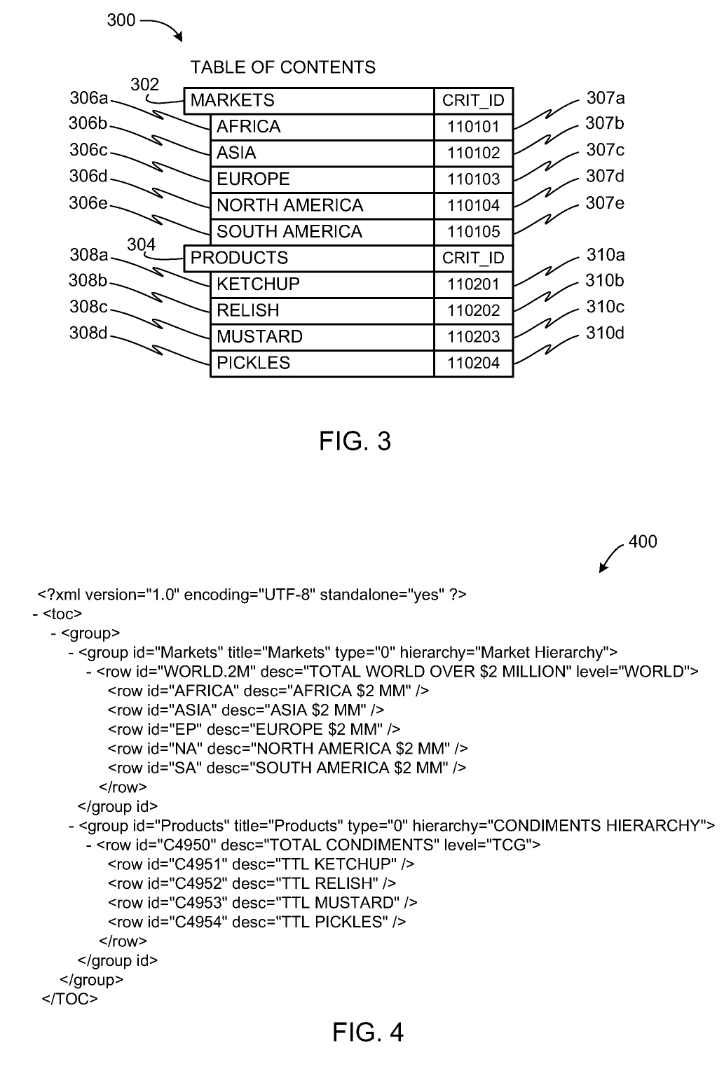

In the example of FIG. 2, a native data source 212 is provided to store and provide information (e.g., the report A information 102 and/or the report B information 104 of FIG. 1) requested by a user via the GUI 100. A table of contents (TOC) 214 stores the plurality of selectable selection criteria associated with the native data source 212. An example TOC representation and an example XML-coded TOC that may be used to implement the TOC 214 are shown in FIGS. 3 and 4, respectively. To render reports corresponding to information retrieved from the native data source 212, the example system 200 of FIG. 2 is provided with a report rendering engine 216. For example, the report rendering engine 216 may be configured to render reports using one or more of chart formats, graph formats, pictorial formats, textual formats, etc. and may be used to render, for example, reports such as those shown in the GUI 100 of FIG. 1. In the illustrated example, the report rendering engine 216 is a native application relative to the portal 202. The report rendering engine 216 is configured to communicate rendered reports to the portal 202 to enable the portal 202 to display the rendered reports via the GUI 100. In some example implementations, the report rendering engine 216 may be implemented using web-based technologies to enable the report rendering engine 216 to render reports displayable via a web page. Although for ease of illustration only one report rendering engine (e.g., the report rendering engine 216) is shown, any number of report rendering engines may be provided.

In the illustrated example, to communicate the TOC 214 having the selection criteria selectable for retrieving information from the native data source 212, the example system 200 is provided with a context criteria interface 218. For example, if the report A information 102 of FIG. 1 is stored in the native data source 212 and a user selects the ‘Volume to Plan’ report selector 114b of FIG. 1 (which corresponds to displaying the report A information 102), the context criteria interface 218 communicates the TOC 214 to the portal 202. In this manner, the portal 202 can populate selectable selection criteria in the criterion selection fields 110a-c of FIG. 1 to enable a user to specify selection criteria associated with the native data source 212.

In the illustrated example, a nonnative data source 220 (e.g., an external data source) is provided to store and provide nonnative report information (e.g., the nonnative report information 106 of FIG. 1) requested by a user via the GUI 100. A nonnative application 222 is provided to exchange nonnative report information between the portal 202 and the nonnative data source 220. The nonnative application 222 may be, for example, a SAP application that is configured to communicate with the nonnative data source 220 and receive information requests from other application(s) (e.g., the portal 202) to provide information from the nonnative data source 220 to those applications. In the illustrated example, although the nonnative data source 220 may be configured to provide a listing of its selectable selection criteria, the nonnative data source 220 may not necessarily provide the selection criteria listing via a TOC. However, in other example implementations, the nonnative data source 220 may have a TOC containing its selectable selection criteria defined using, for example, nonnative values (e.g., nonnative descriptions, nonnative keys, nonnative ID's, etc.).

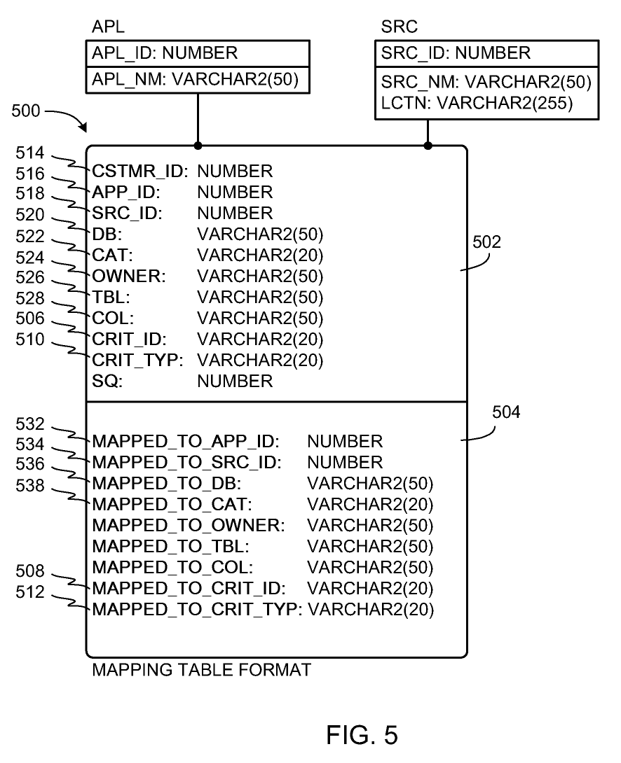

In the example of FIG. 2, the context service interface 208 is provided with a data mapper 223 configured to generate a mapping table 224, which provides a mapping of selection criteria associated with different data sources. In the illustrated example, the mapping table 224 maps native selection criteria corresponding to the native data source 212 to nonnative selection criteria corresponding to the nonnative data source 220. In an example implementation, the TOC 214 of the native data source 212 may include a native ‘North America Sales’ criterion corresponding to sales of every country in North America while the nonnative data source 220 may have a nonnative ‘United States’ criterion corresponding to sales information of only the United States. To enable a user to view nonnative report information (e.g., the nonnative report information 106 of FIG. 1) stored in the nonnative data source 220 based on the selected ‘North America Sales’ criterion associated with the TOC 214, the mapping table 224 maps the nonnative ‘United States’ criterion associated with the nonnative data source 220 to the native ‘North America Sales’ criterion associated with the native data source 212. In this manner, when the user requests to view the nonnative report information 106 based on the specified native ‘North American Sales’ criterion, the nonnative application 222 can retrieve the requested information from the nonnative data source 220 based on the nonnative ‘United States’ criterion indicated via the criterion mapping in the mapping table 224. An example mapping table format that may be used to implement the mapping table 224 is shown in FIG. 5. An example mapping table is shown in FIG. 6. Although for ease of illustration, only one mapping table (e.g., the mapping table 224) is shown in FIG. 2, the example system 200 may be provided with any number of mapping tables.

To enable the nonnative application 222 to retrieve requested information from the nonnative data source 220 based on the selection criteria specified via the criteria selection toolbar 108 (FIG. 1), the example system 200 of FIG. 2 is provided with a context external interface 226. For example, to retrieve the nonnative information 106 (FIG. 1) from the nonnative data source 220, the example portal 202 of FIG. 2 forwards a request to the nonnative application 220 including the context ID associated with the context data structure 204. The context external interface 226 then communicates the context ID to the context service interface 208 with a request to retrieve the nonnative selection criteria associated with the nonnative data source 220 that correspond to the user-specified native selection criteria stored in the context data structure 204. In the illustrated example, the nonnative selection criteria are mapped to the native selection criteria in the mapping table 224. In response to receiving the request from the context external interface 226, the context service interface 208 can retrieve the nonnative selection criteria from the mapping table 224 and communicate the nonnative selection criteria to the context external interface 226. In this manner, the nonnative application 222 can retrieve the nonnative report information 106 (FIG. 1) from the nonnative data source 220 corresponding to the native user-specified selection criteria specified via the GUI 100 and stored in the context data structure 204.

In the illustrated example, the context external interface 226 is also configured to communicate a nonnative TOC associated with the nonnative data source 220 to the portal 202 via the context service interface 208 to enable the portal 202 to populate the criteria selection toolbar 108 with available nonnative selection criteria associated with the nonnative data source 220. If the user subsequently selects to retrieve other nonnative information from the nonnative data source 220, the context external interface 226 can provide the requested information based on the nonnative selection criteria specified by the user via the criteria selection toolbar 108 without needing to use a mapping between native and nonnative selection criteria again. That is, the data mapper 223 may be configured to map between native and nonnative selection criteria only when a user elects to navigate from a native report to a nonnative report or from a nonnative report to a native report. However, the data mapper 223 may be configured not to map between native and nonnative selection criteria when a user navigates to different nonnative reports that use nonnative information retrieved from the nonnative data source 220.

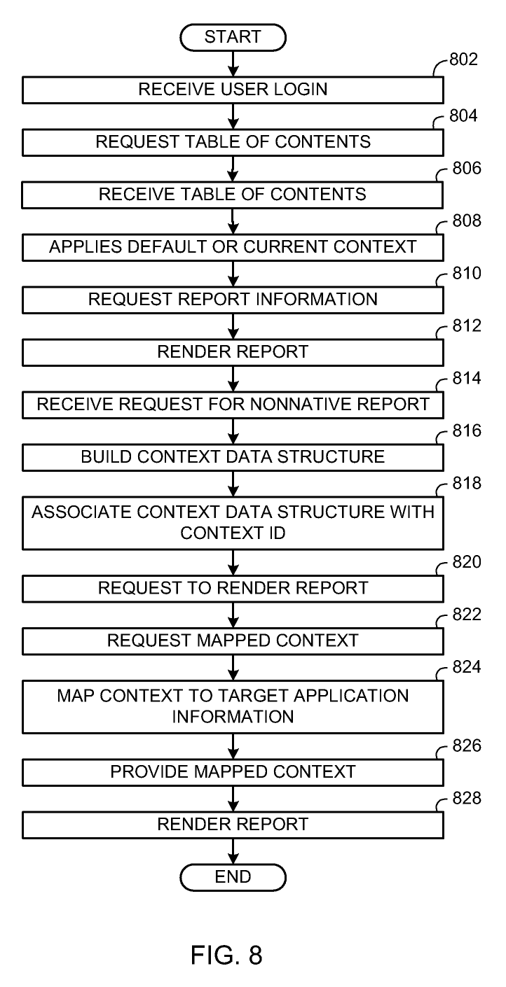

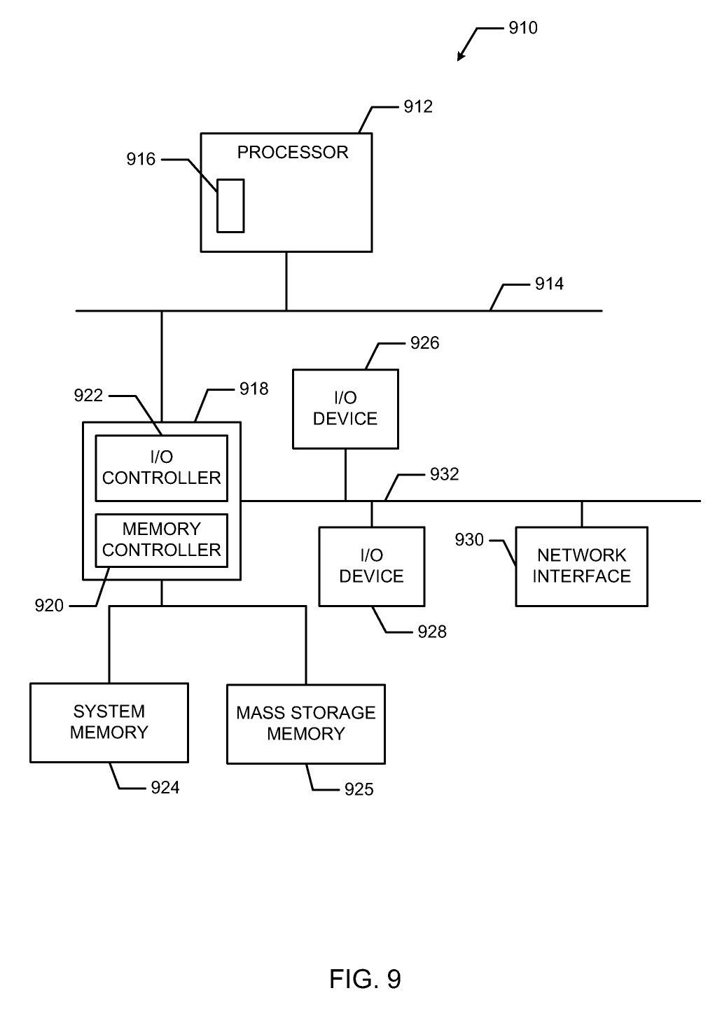

The context manager 206, the context service interface 208, the context criteria interface 218, the data mapper 223, and the context external interface 226 may be implemented using any desired combination of hardware, firmware, and/or software. For example, one or more integrated circuits, discrete semiconductor components, or passive electronic components may be used to implement these structures. Additionally or alternatively, some or all of the context manager 206, the context service interface 208, the context criteria interface 218, the context external interface 226, and/or parts thereof, may be implemented using instructions, code, and/or other software and/or firmware, etc. stored on a machine accessible medium that, when executed by, for example, a processor system (e.g., the example processor system 910 of FIG. 9), perform the operations represented in the flowchart of FIG. 8. In the illustrated example, some or all of the context manager 206, the context service interface 208, the context criteria interface 218, and/or the context external interface 226 may be distributed among various network entities (e.g., various servers) in the example system 200. However, in alternative example implementations, some or all the context manager 206, the context service interface 208, the context criteria interface 218, and/or the context external interface 226 may be implemented using the same network entity (e.g., the same server).

FIG. 3 is an example table of contents 300 that may be used to implement the table of contents 214 of FIG. 2. In the illustrated example, the TOC 300 includes two types of criteria, namely, a markets criterion type 302 and a products criterion type 304. Under the markets criterion type 302, the TOC 300 includes a plurality of criteria 306a-e, each of which is associated with a unique criterion ID 307a-e. Under the products criterion type 304, the TOC 300 includes a plurality of criteria 308a-d, each of which is also associated with a unique criterion ID 310a-d. In the illustrated example, the portal 202 (FIG. 2) can use the criteria 306a-e and 308a-d to populate selectable criteria in the criterion selection fields 110a-c of FIG. 1. For example, the portal 202 may populate the ‘Market’ criterion selection field 110a with any or all of the criterion 306a-e and populate the ‘Product’ criterion selection field 110b with any or all of the criterion 308a-d. In this manner, when a user selects, for example, the ‘Market’ criterion selection field 110a, the criterion 306a-e are shown via a drop-down list. In an example implementation, the TOC 300 may be implemented using a TOC 400 implemented using XML as shown in FIG. 4.

FIG. 5 depicts an example mapping table format 500 that may be used to implement the mapping table 224 of FIG. 2. In the illustrated example, the example mapping table format 500 includes a native parameter portion 502 and a nonnative mapped parameter portion 504. Although the parameter portions 502 and 504 are described as corresponding to native and nonnative parameters, in other example implementations, the mapping table format 500 may be used to map selection criteria associated with different native data sources. For example, the mapping table format 500 could be used to map selection criteria associated with a first native data source to different selection criteria associated with a second native data source. In yet other example implementations, the mapping table format 500 may be used to map selection criteria associated with different nonnative data sources. For example, the mapping table format 500 could be used to map selection criteria associated with a first nonnative data source to different selection criteria associated with a second nonnative data source.

In the illustrated example of FIG. 5, the native parameter portion 502 includes a criterion ID parameter 506 that is mapped to a mapped-to criterion ID parameter 508 in the nonnative parameter portion 504. In addition, the native parameter portion 502 includes a criterion type parameter 510 that is mapped to a mapped-to criterion type parameter 512 in the nonnative mapped parameter portion 504. The criterion type parameter 510 may be used to indicate whether a criterion indicated by the criterion ID parameter 506 is, for example, a market criterion type (e.g., the markets criterion type 302 of FIG. 3) or a product criterion type (e.g., the products criterion type 304 of FIG. 3). Other criteria in the example mapping table format 500 of FIG. 5 include a customer ID 514 to indicate a customer (e.g., a user) of a portal service (e.g., a service provided by the portal 202 of FIG. 2), an application ID 516 to identify an application (e.g., a native application or the report rendering engine 216 of FIG. 2) corresponding to a particular mapping table entry, a source ID 518 to identify a data source (e.g., the native data source 212 of FIG. 2) corresponding to the particular mapping table entry, a database parameter 520 to indicate the name of the data source, a category parameter 522 to identify the categorical type (e.g., financial type information, volume type information, time-based information, etc.) of information stored by the data source, an owner parameter 524 to identify an owner of the data source, and a table parameter 526 and a column parameter 528 to identify a particular table and a column of the table within the data source in which the information corresponding to the mapped criterion is stored.

The nonnative mapped parameter portion 504 includes ‘mapped-to’ parameters corresponding to the parameters 506, 510, 516, 518, 520, 522, 524, 526, and 528. For example, a mapped-to application ID 532 is mapped to the application ID 516 and indicates the ID of a nonnative application (e.g., the nonnative application 222 of FIG. 2) to which a native application is mapped. A mapped-to source ID 534 is mapped to the source ID 518 and indicates the ID of a nonnative data source (e.g., the nonnative data source 220 of FIG. 2). A mapped-to database parameter 536 is mapped to the database parameter 520 and indicates the name of a nonnative data source (e.g., the nonnative data source 220). A mapped-to category parameter 538 is mapped to the category parameter 522 and indicates the name of a nonnative categorical type.

FIG. 6 is an example mapping table data structure 600 implemented in accordance with the example mapping table format 500 of FIG. 5. For simplicity of illustration, the example mapping table data structure 600 includes three mapping entries 602a-c. However, the example mapping table data structure 600 shown in FIG. 6 may include any number of mapping entries. In the illustrated example, the mapping table data structure 600 includes a ‘native database’ parameter value 604 in a database column 606 that is mapped to a ‘nonnative database’ parameter value 608 in a mapped-to-database column 610. The ‘native database’ parameter value 604 may correspond to the native data source 212 of FIG. 2 and the ‘nonnative database’ parameter value 608 may correspond to, for example, the nonnative data source 220 of FIG. 2.

In the illustrated example, the mapping entries 602a-c are used to map selection criteria associated with a time-based or period-based category as indicated by the period parameter 612 stored in a category column 614. The mapping entry 602a is used to map a native database criterion ID ‘110505’ 616 corresponding to a time period of Nov. 5, 2005 to a nonnative database criterion ID ‘1105’ 618 corresponding to a time period of November 2005. In the illustrated example, the nonnative database stores data corresponding to a one-month time period (e.g., November 2005), but it does not store data corresponding to only a one-day time period (e.g., the one day time period of Nov. 5, 2005) as does the native database. Thus, the mapping entry 602a is used to map the native database criterion ID ‘110505’ 616 associated with the native database to the nonnative database criterion ID ‘1105’ 618 associated with the nonnative database.

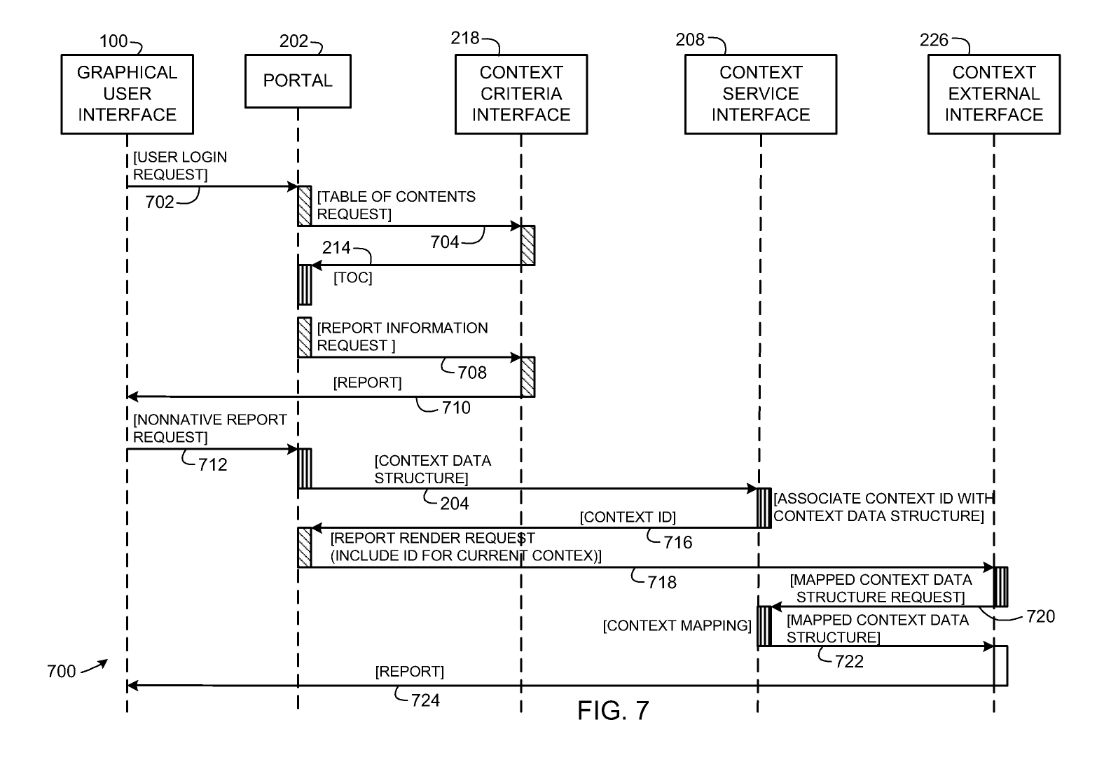

FIG. 8 is a flowchart representative of example machine readable instructions that may be executed by one or more entities of the example system 200 of FIG. 2 to enable the portal 202 of FIG. 2 to retrieve information (e.g., the report A information 102, the report B information 104, and/or the nonnative report information 106 of FIG. 1) from a plurality of separate data sources (e.g., the native data source 212 and/or the nonnative data source 220 of FIG. 2) without requiring a user to repeatedly provide selection criteria indicative of the information to be retrieved. Although the example machine readable instructions are described with reference to the flowchart of FIG. 8, persons of ordinary skill in the art will readily appreciate that other methods of implementing the example system 200 of FIG. 2 may additionally or alternatively be used. For example, the order of execution of the blocks depicted in the flowchart of FIG. 8 may be changed, and/or some of the blocks described may be rearranged, eliminated, or combined. Some of the operations of the flowchart of FIG. 8 described below are described in connection with an example timing diagram 700 of FIG. 7 representative of example communication transactions between entities of the example system 200 of FIG. 2.

Turning in detail to FIG. 8, initially, the GUI 100 (FIG. 1) communicates a user login request 702 (FIG. 7) to the portal 202 (block 802). The portal 202 then communicates a TOC request 704 (FIG. 7) to the context criteria interface 218 to, upon initial login, request a TOC (block 804). For example, the user may set the portal 202 to always default to retrieving a TOC from a particular data source or from a data source that the user was working with during a previous login session. Thus, if the default data source is the native data source 212 (or if the user was working with the native data source 212 during a previous login session), the portal 202 may request the TOC 214 associated with the native data source 212 at block 804. The portal 202 then receives the TOC 214 (FIG. 7) from the context criteria interface 218 (block 806), and the portal 202 applies a default context or a current context (block 808) based on the selection criteria in the TOC 214. For example, the portal 202 may use a default context if the user has set the portal 202 to, upon initial login, always default to a particular context (e.g., to particular selection criteria shown in the criterion selection fields 110a-c) or to a context that the user specified during a previous login session. Alternatively, the portal 202 may use a current context if the user, after an initial login, has specified particular selection criteria (e.g., selection criteria different from default selection criteria) via the criterion selection fields 110a-c.

The portal 202 then communicates a report information request 708 (FIG. 7) to the context criteria interface 218 to request report information (block 810). For example, the portal 202 may communicate the report information request 708 in response to a user selecting one of the report selectors 114b-c of FIG. 1. The context criteria interface 218 then causes the report rendering engine 216 (FIG. 2) to communicate a report 710 (FIG. 7) to the GUI 100 to render the report 710 having the requested information (block 812). For example, the report rendering engine 216 may generate the report 710 to include the report A information 102 (FIG. 1).

The portal 202 then receives a nonnative report request 712 (FIG. 7) from the GUI 100 (block 814). For example, the GUI 100 may communicate the nonnative report request 712 to the portal 202 in response to a user selecting the report selector 114d of FIG. 1. The portal 202 then uses the context manager 206 to generate the context data structure 204 (FIGS. 2 and 7) (block 816), and the context service interface 208 associates a context ID 716 (FIG. 7) with the context data structure 204 (block 818). The portal 202 then communicates a report render request 718 (FIG. 7) (which includes the context ID 716) to the context external interface 226 to request the nonnative application 222 to render a report (block 820). The context external interface 226 then communicates a mapped context data structure request 720 (FIG. 7) to the context service interface 208 to request a mapped context data structure (block 822). In the illustrated example, the mapped context data structure request 720 includes the context ID 716 to specify the context data structure 204 and to cause the context service interface 208 to map the selection criteria in the context data structure 204 to nonnative selection criteria in a mapped context data structure. In the illustrated example, the context service interface 208 uses the mapping table 224 of FIG. 2 to generate the mapped context data structure to include nonnative selection criteria mapped to the native selection criteria in the context data structure 204 as described above in connection with FIGS. 5 and 6.

The context service interface 208 then maps the context data structure 204 to the target application (block 824). For example, the data mapper 223 of the context service interface 208 can map the native selection criteria in the context data structure 204 to nonnative selection criteria corresponding to the nonnative application 222. The context service interface 208 then communicates a mapped context data structure 722 (FIG. 7) to the context external interface 226 (block 826), and the context external interface 226 causes the nonnative application 222 to communicate a report 724 (FIG. 7) to the GUI 100 to render the report 724 having the requested information (block 828). For example, the nonnative application 222 may generate the report 724 to include the nonnative report information 106 of FIG. 1. The process of FIG. 8 is then ended.

FIG. 9 is a block diagram of an example processor system 910 that may be used to execute the example machine readable instructions of FIG. 8 to implement the example systems, apparatus, and/or methods described herein. As shown in FIG. 9, the processor system 910 includes a processor 912 that is coupled to an interconnection bus 914. The processor 912 includes a register set or register space 916, which is depicted in FIG. 9 as being entirely on-chip, but which could alternatively be located entirely or partially off-chip and directly coupled to the processor 912 via dedicated electrical connections and/or via the interconnection bus 914. The processor 912 may be any suitable processor, processing unit or microprocessor. Although not shown in FIG. 9, the system 910 may be a multi-processor system and, thus, may include one or more additional processors that are identical or similar to the processor 912 and that are communicatively coupled to the interconnection bus 914.

The processor 912 of FIG. 9 is coupled to a chipset 918, which includes a memory controller 920 and an input/output (I/O) controller 922. As is well known, a chipset typically provides I/O and memory management functions as well as a plurality of general purpose and/or special purpose registers, timers, etc. that are accessible or used by one or more processors coupled to the chipset 918. The memory controller 920 performs functions that enable the processor 912 (or processors if there are multiple processors) to access a system memory 924 and a mass storage memory 925.

The system memory 924 may include any desired type of volatile and/or non-volatile memory such as, for example, static random access memory (SRAM), dynamic random access memory (DRAM), flash memory, read-only memory (ROM), etc. The mass storage memory 925 may include any desired type of mass storage device including hard disk drives, optical drives, tape storage devices, etc.

The I/O controller 922 performs functions that enable the processor 912 to communicate with peripheral input/output (I/O) devices 926 and 928 and a network interface 930 via an I/O bus 932. The I/O devices 926 and 928 may be any desired type of I/O device such as, for example, a keyboard, a video display or monitor, a mouse, etc. The network interface 930 may be, for example, an Ethernet device, an asynchronous transfer mode (ATM) device, an 802.11 device, a digital subscriber line (DSL) modem, a cable modem, a cellular modem, etc. that enables the processor system 910 to communicate with another processor system.

While the memory controller 920 and the I/O controller 922 are depicted in FIG. 9 as separate functional blocks within the chipset 918, the functions performed by these blocks may be integrated within a single semiconductor circuit or may be implemented using two or more separate integrated circuits.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A method of retrieving information, comprising:
receiving a first data criterion associated with a native data source;
storing the first data criterion in a first data structure in response to a user navigating from a native report corresponding to the native data source to a nonnative report corresponding to a nonnative data source;
associating an identifier with the first data structure;
mapping the first data criterion to a second data criterion associated with the nonnative data source; and
retrieving information from the nonnative data source based on the second data criterion.

2. A method as defined in claim 1, generating a mapping data structure based on the mapped data criterion and the identifier.

3. A method as defined in claim 2, wherein generating the mapping data structure comprises mapping a native data source identifier to a nonnative data source identifier of the nonnative data source.

4. A method as defined in claim 2, wherein generating the mapping data structure comprises mapping a native application identifier to a nonnative application identifier of a nonnative application to access the nonnative data source.

5. A method as defined in claim 2, further comprising retrieving the information from the nonnative data source by:
accessing the second data criterion in the first data structure based on the identifier; and
causing a nonnative application to retrieve the information from the nonnative data source based on the second data criterion.

6. A method as defined in claim 1, further comprising mapping the first data criterion to the second data criterion using an extensible markup language format.

7. A method as defined in claim 1, wherein the native data criterion is indicative of second information stored in the native data source, and wherein the nonnative data criterion is indicative of the information stored in the nonnative data source.

8. A method of providing information access, comprising:
displaying a criteria selection interface control;
displaying a first report selector associated with a first native data source, a second report selector associated with a second native data source, and a third report selector associated with a nonnative data source;
populating the criteria selection interface control with a plurality of native criteria associated with the first and second native data sources;
maintaining the plurality of native criteria the same in the criteria selection interface control in response to detecting a selection of the second report selector; and
mapping at least one of the plurality of native criteria to at least one of a plurality of nonnative criteria associated with the nonnative data source in response to detecting a selection of the third report selector.

9. A method as defined in claim 8, further comprising populating the criteria selection interface control with the plurality of nonnative criteria associated with the nonnative data source in response to detecting the selection of the third report selector.

10. A method as defined in claim 9, further comprising receiving a table of contents having the plurality of nonnative criteria to populate the criteria selection interface control in response to detecting the selection of the third report selector.

11. A method as defined in claim 8, further comprising:
receiving the at least one of the plurality of native criteria via the criteria selection interface prior to detecting the selection of the third report selector;
mapping the received native criterion to a nonnative criterion in response to detecting the selection of the third report selector; and
displaying the nonnative criterion via the criteria selection interface control.

12. A method as defined in claim 11, further comprising generating a mapping data structure to store the native criterion in association with the nonnative criterion and to store a native data source identifier in association with a nonnative data source identifier corresponding to the nonnative data source.

13. A method as defined in claim 12, further comprising associating an identifier with the mapping data structure, accessing the nonnative criterion in the mapping data structure based on the identifier, and retrieving information from the nonnative data source based on the nonnative criterion.

14. A method as defined in claim 8, wherein the plurality of native criteria are indicative of first information stored in the native data source, and wherein the plurality of nonnative criteria are indicative of second information stored in the nonnative data source.

15. A system to retrieve information, comprising:
a portal interface to display a criteria selection interface control, a first report selector corresponding to a first native data source, a second report selector corresponding to a second native data source, and a third report selector corresponding to a nonnative data source;
a criteria interface to retrieve a plurality of native criteria corresponding to the first and second native data sources;
an external interface to retrieve a plurality of nonnative criteria corresponding to the nonnative data source, wherein the portal interface populates the criteria selection interface control with the plurality of native criteria associated with the first and second native data sources in response to detecting a selection of at least one of the first report selector or the second report selector; and
a data mapper to map a user-selected native criterion to a nonnative criterion in response to detecting a selection of the third report selector.

16. A system as defined in claim 15, wherein the portal interface populates the criteria selection interface control with the plurality of nonnative criteria in response to detecting the selection of the third report selector.

17. A system as defined in claim 15, wherein the portal interface is further to display the nonnative criterion via the criteria selection interface control.

18. A system as defined in claim 15, wherein the data mapper is further to map a native data source identifier in association with a nonnative data source identifier corresponding to the nonnative data source.

19. A system as defined in claim 16, further comprising a service interface to associate an identifier with the mapping of the user-selected native criterion to the nonnative criterion, wherein the service interface communicates the nonnative criterion to the external interface based on the identifier, and wherein the external interface retrieves information from the nonnative data source based on the nonnative criterion.

20. A system as defined in claim 15, further comprising a report rendering engine to generate a report based on data retrieved using at least one of the plurality of native criteria or nonnative criteria.

21. A system as defined in claim 15, wherein the plurality of native criteria are indicative of first information stored in the native data source, and wherein the plurality of nonnative criteria are indicative of second information stored in the nonnative data source.

22. A machine readable medium storing a data structure to enable data access to a nonnative data source based on native criteria corresponding to a native data source, the data structure comprising:
a native criterion identifier stored in association with a nonnative criterion identifier, wherein the native criterion identifier is indicative of a native criterion of a native data source, and wherein the nonnative criterion identifier is indicative of a nonnative criterion of a nonnative data source and corresponding to the native criterion;
a native data source identifier stored in association with a nonnative data source identifier, wherein the native data source identifier is indicative of the native data source and the nonnative data source identifier is indicative of the nonnative data source; and
a user identifier indicative of a user for which the data structure is stored.

23. A machine readable medium as defined in claim 22, wherein the data structure further comprises a native application identifier stored in association with a nonnative application identifier, wherein the native application identifier is indicative of a native application configured to access first information in the native data source based on the native criterion, and wherein the nonnative application identifier is indicative of a nonnative application configured to access second information in the nonnative data source based on the nonnative criterion.

24. A machine readable medium as defined in claim 22, wherein the data structure further comprises a native criteria type parameter stored in association with a nonnative criteria type parameter.

25. A machine readable medium as defined in claim 22, wherein the data structure further comprises a native category parameter stored in association with a nonnative category parameter, wherein the native category parameter is indicative of the categorical type of information stored in the native data source, and wherein the nonnative category parameter is indicative of the categorical type of information stored in the nonnative data source.
